(19) United States
(12) Patent Application Publication
(10) Pub. No.: US 2007/0156478 A1
(43) Pub. Date: Jul. 5, 2007

(54) High performance business framework and associated analysis and diagnostic tools and processes

(75) Inventors: Richard Timothy Breene, Weston, MA (US); Paul F. Nunes, Canton, MA (US); Walter E. Shill III, Reston, VA (US); Robert J. Thomas, Brookline, MA (US); David Brian Mann, Farnham Common Bucks (GB); Susan Cantrell, Lindsborg, KS (US); Anita Marie Thompson, Highland Park, IL (US); Narendra P. Mulani, Lake Forest, IL (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 11/524,511

(22) Filed: Sep. 21, 2006

Related U.S. Application Data
(60) Provisional application No. 60/719,574, filed on Sep. 23, 2005.

(51) Int. Cl. G06F 9/44

(52) U.S. Cl. 705/7

(57) ABSTRACT

Disclosed is a high performance business framework and related tools and processes for describing how known high performance businesses derive performance contributions from three building blocks. The present invention provides methods and tools for researching, measuring and quantifying these three building blocks to enable assessments to be made of various companies in various industries and methods and tools for enabling these various companies to identify and adopt solutions that enable them to model themselves after high performers.

### CROSS REFERENCE TO RELATED APPLICATIONS

The present application claims the benefit of priority of prior co-owned U.S. Provisional Patent Application Ser. No. 60/719,574, filed Sep. 23, 2005.

### FIELD OF THE INVENTION

The present invention relates to a framework and related tools and processes for identifying insights within key building blocks of high performance businesses associated with one or more business entities and for identifying areas of a business entity that could be revised or addressed to improve performance of those entities. More particularly, the present invention relates to a framework and related analysis and diagnostic tools and processes for assisting businesses in achieving high performance.

### BACKGROUND OF THE INVENTION

High level executives have been conventionally trained and advised to compete on capabilities. More specifically, they have been trained to believe that strategically they are posed with two alternative options. In the first option, they view capabilities as deriving from core competencies, which are areas of specialized expertise that companies create through organizational focus over time. In the second option, they view business capabilities as deriving from the processes that are central to the execution of the company's strategy. How executives chose to view their business capabilities in turn dictates how they approach managing their business.

While the arguments used to support these two conventional wisdom approaches to capability development are compelling, they tend to break down in practice. Management discussions centered on capabilities as the embodiment of strategy in action via business processes, for example, can often be reduced to the observation that what is needed is “a good strategy well executed.” This, of course, is seen by most contemporary executives as merely stating the obvious. Similarly, a focus on core competence strategies can create poor performance when a fixation on capabilities excellence causes a company to lose sight of the broader market. Companies can become outpaced by the market strategically, leaving it to become, for example, the best buggy-whip maker in an increasingly automotive world.

Understandably, there is significant danger that an unwary company could assume that lasting business success comes from achieving world-class excellence in one or more processes. Current market research, however, indicates that in practice conventional process excellence often fails companies as a means to achieve high performance. For example, when considering the airline and wireless communications industries, where although there are more than a few companies with exceptional process capability, such as nearly flawless flight operations or superior wireless network management, profitable enterprises are hard to find.

Furthermore, during the past two decades, some of the world's most admired public companies have been explicitly built on the promise of dominant scale. One of the axioms of business analysis is that all industries consolidate as they mature, and that those companies that scale up and survive the shakeout inevitably win big. By extension, in an era of globalized markets, global survivors are presumed to win very big. In fact, during the past two decades, as sector after sector has moved through consolidation, some of the most admired public companies have been explicitly built on the promise of dominant scale. There are significant limitations to the advantages of size. Rather than focus on a scale-as-endgame strategy, high-performance businesses pay greater attention to achieving the right balance between scale and other key performance factors.

Nevertheless, faith in the scale-as-endgame strategy retains a powerful hold on many business thinkers. Contrary to this belief, however, mounting evidence suggests that there are significant limitations to the advantages of scale. High-performance businesses, defined as those that consistently exceed their peers in total return to shareholders, as well as in revenue and profit growth, are rarely those that have sought success through market position and scale alone. From automobile manufacturers to personal computer makers, the list of companies that dominated their industries for a time, only to fade away as shifts in demand, technology or business models eroded their base, is a long one.

It should be understood, however, that high-performance businesses do not disregard the need to attain the right scale and position in their markets. In the right context, scale can, of course, deliver certain well-documented competitive advantages, including, for example, increased production efficiencies and purchasing power, and greater brand prominence and more widespread amortization of general and administrative costs.

Given that scale-as-endgame strategies are, at best, unreliable at delivering high performance, there remains needs for better approaches that companies can take to improve their business performance while at the same time being mindful of the contribution scale can play in preserving long-term competitiveness.

### SUMMARY OF THE INVENTION

The various embodiments of the present invention recognize that the scale-as-endgame approach prevalent in contemporary management thinking is not sufficient to sustain high performance. It has been identified in accord with the present invention that a large percentage of high performers show some measure of scale, such as within a business segment, for example, or a particular geographic area. However, in only a few particular cases will high performers be the absolute revenue leaders in their industries. Indeed, many high performers compete successfully at a fraction of the size of revenue leaders. Thus, the embodiments of the present invention are adapted to help managers to readily recognize and internalize that scale is just one element among many that may contribute to high performance when properly utilized and balanced with other elements of high performance business.

For example, an analysis of data concerning the 172 companies that had spent time on Fortune's list of the 50 largest companies shows that between 1955 and 1995, only 5 percent were able to sustain a real, inflation-adjusted growth rate of more than 6 percent across their entire tenure in this group. This analysis also determined that fewer than 5 percent of all publicly traded companies maintain a total return to shareholders greater than their industry peers for more than 10 years. This is believed to be because, to sustain such superior performance over the long term, companies must successfully navigate across business cycles in which industry structural conditions, key success factors, competition and business models all inevitably change. Embodiments of the present invention thus recognize that market position and scale strategies alone are not sufficient, and can even be a liability, in navigating these transitions.

Additionally, it has been determined in accord with the present invention that there is even less correlation between return to shareholders and scale-driven strategies by examining the performance of the US companies that grew their capital bases most (measured in actual dollars). Companies focused primarily upon scale as a strategic end game were unsuccessful in growing market values in proportion to capital growth. Very few could keep up the pace, and most diluted their market value-to-capital ratio.

These market analyses that underpin the present invention indicate that the source and nature of scale benefits are largely overestimated and overstated. The increased complexities that come with scale often lead to their own “diseconomies,” making mergers and acquisitions and other rapid scaling strategies currently relied upon excessively in pursuit of scale. Large-scale enterprises, particularly those that rely on fixed assets, become more vulnerable to disruption as they grow.

In this regard, management must keep a company tightly focused on the renewable combination of customer-oriented capabilities, scale and its own performance anatomy. Future success is predicated not on new hit products but upon a vital, self-renewing high-performance business model.

To this end, embodiments of the present invention utilize a framework and related processes and tools for identifying and diagnosing high performance companies. The framework acknowledges and incorporates market research data reflecting that high performance companies typically evolve according to a lifecycle pattern that generally is comprised of five stages of development. First, these companies master a core competence. Second, they focus relentlessly on innovation and improvement within the core competence, driving down the experience and learning curve as others seek to copy or emulate their entry success. Third, they extend the initial core competence by linking it to other critical market-relevant competencies that, when taken in combination, form a distinct business model. Fourth, they seek out new market opportunities, using the business model to give themselves a competitive advantage over existing incumbents. Finally, these companies leverage their market position, the distinctive capabilities built into their business models and their high-performance anatomy in a continuously renewing cycle.

Various embodiments of the present invention utilize a high performance business framework for describing how the success of such high performance businesses derives from focusing greater attention on balancing the performance contributions of three building blocks to a high performance business as opposed to focusing on obtaining scale for scale's sake or other “tried and true” axioms. The present invention thus provides methods and tools for researching, measuring and quantifying these three building blocks to enable assessments to be made of various companies in various industries to enable them to model themselves after high performers.

The present invention in its various preferred embodiments comprises a framework and methodology that establishes mechanisms for identifying business entities that are a “high performance business” (or “HPB”), and comparing business entities to high performance businesses in their respective industries. What may be characterized as high performance with regard to such business entities preferably is defined herein as reflecting both the company's ability to succeed in today's markets and its positioning for the future—its potential for capturing and profiting from new markets going forward.

The comprehensive research of peer comparisons within specific industries underpinning the present invention has demonstrated that leading companies, while seemingly different in characteristics and circumstances when compared on their surface, share common attributes and behaviors that drive their superior performance. According to the embodiments as described herein, these attributes are measurable through the application of consistent, transparent, credible financial and alternative performance metrics described from the peer comparisons. Furthermore, these attributes can be copied by business entities seeking to improve the building blocks of their own organization, thus replicated by practical solutions for would-be high-performance organizations who are diagnosed and found to lack such attributions.

While many companies compete on the basis of a single point of differentiation, the competitive essence of high performers is almost always achieved through the balance, alignment and renewal of the three building blocks of high performance defined by the framework of the present invention, namely, market focus and position, distinctive capabilities and performance anatomy.

The high performance business framework according to embodiments of the present invention is established from a universe of financial and other data concerning companies in various industries and markets. A screening of those companies in the universe was employed to identify business entities that would qualify as high performance businesses. Each of these identified business entities were then used to identify “discipline characteristics” for five main disciplines, namely, visioning, resource optimization, business integration, performance management, and change management, which disciplines span across the three key building blocks of high performance businesses (i.e., market focus and position, distinctive capabilities, and performance anatomy).

The market focus and position business attribute reflects the parts of a high performance business that maximizes growth opportunities and structural economic advantage. Similarly, the distinctive capabilities building block maximizes competitive differentiation for high performance businesses, while the performance anatomy building block reflects a high performance business's attempts to out-execute the competition.

Companies seeking to improve their competitive essence are most apt to fail when they lose the critical sense of balance required for high performance, such as by favoring one building block to the exclusion of the others. As noted above, for example, many companies currently appear to be overemphasizing the importance of scale in their business, which amounts to a dangerous over-reliance one competitive advantage enabled through the market focus and position building block. Organizations also put their competitive essence at risk when they fail to refresh and renew the building blocks. For example, by continuing to rely on capabilities that are no longer distinctive, or by resting on the laurels of a once-celebrated corporate culture long after it has lost its vitality can lead to weaknesses in the distinctive capabilities building block. The embodiments of the present invention thus enable managers of would be high-performance companies to continuously balance, align and renew the building blocks by providing a framework and tools for analyzing a company's current position relative to high performance businesses and providing insight concerning remedial actions that may be undertaken to improve performing of this balancing.

In the frameworks according to embodiments of the present invention, five discipline types intersect witch each of the three building blocks, defining fifteen discipline characteristics (five for each building block) that are highly indicative of high performance businesses when the components of each building block are analyzed. The five discipline types include visioning, resource optimization, business integration, performance management, and change management. No one attribute or discipline characteristic can give a company a building block of a high performance business, but together, however, these five characteristic types in each building block consistently make the difference between business practices that are good but unexceptional, and those that make a real and lasting difference in company performance. An examination of each of the five discipline characteristic elements of each building block reveals how companies actually build them, and what other companies must do to find their own path to achieving them.

The framework in turn enables processes according to other embodiments of the present invention to be employed. Such processes utilize the framework to identify which business entities are high performance businesses by establishing qualitative and quantitative metrics for the various discipline characteristics across the three main building blocks of a high performance business, and by establishing diagnostics for accessing such metrics. This, in turn, provides informative and valuable information regarding the financial performance of a target business entity and their competitors that can be used in making strategic decisions and forecasts. Further, the processes utilizing the framework of the present invention provide mechanisms for identifying, understanding and communicating the attributes of high performance businesses.

One process according to embodiments of the present invention includes a high performance business emulation process that establishes and utilizes a high performance business framework to assist a subject company in emulating the building blocks of, and thus the operation and performance of, high performance businesses. The process includes six steps that can be broken three steps each into a research phase and an execution phase. The research phase first screens for and identifies high performance businesses from various different industries, and then, for each industry, drivers of high performance business are identified. Thereafter, the drivers are synthesized into an overall high performance business framework that may be used to diagnose and examine subject companies during the execution phase of the emulation process.

During the emulation phase, the high performance business framework is first utilized to diagnose the key differences in terms of practices and performance between the subject company being studied and the high performance businesses identified during the research phase. These key differences are then liked to solutions intended to move the subject company to a position closer resembling that of identified high performance businesses. Finally, the solutions are implemented and managed in order to transform the practices and performance of the subject company.

In preferred embodiments of the invention, various diagnostics are established and then utilized to diagnose the key differences between the subject companies and the identified high performance businesses. These diagnostics are adapted to obtain the appropriate data and analyze the metrics relating to the discipline characteristics under each building block of the framework. For each building block answers to key questions can be asked to relevant executives within the business entity being diagnosed. Additionally, discipline characteristics for the distinctive capabilities building block can be further assessed and measured using an executive level diagnostic, which comprises a questionnaire (more lengthy relative to the “key questions”) being circulated to various different members of lower management. A similar deeper level diagnostic, labeled an organizational performance assessment, can be performed with regard to the performance anatomy building block for similar purposes.

The end result of these assessments could be, for example, correlated data that can be provided to management of the diagnosed business entity in the form of various reports and data describing the various discipline characteristics of the diagnosed entity relative to high performance businesses, such as in graphic or other readily digestible form.

In this regard, a first aspect of the present invention includes a computer storage medium encoded with instructions embodying a computer program. The computer program is adapted to perform operations to assist a subject company in achieving high performance by emulating the characteristics of known high performance businesses. The operations comprise diagnosing the gap between a subject company and the identified high performance businesses using a high performance business framework. The high performance business framework reflects industry drivers identified for known high performance businesses identified within a plurality of industries. The high performance business framework defines a plurality of discipline characteristics common to known high performance businesses as the intersection of a plurality of building blocks with a plurality of discipline types. The diagnosing is performed by correlating data collected from assessments for each the building block. The operations further include linking diagnosed gap areas affecting the subject company with a repository of stored solution overviews particularly adapted for improving the gap areas. This linking correlates various business strategies with a plurality of gap areas and the overview module providing information relevant to each business strategy, and the relevant information is useful for the understanding, assessing, and implementing of a particular strategy recommendation for the subject company.

A further aspect of the present invention includes a method for assisting a subject company in achieving high performance by emulating the characteristics of known high performance businesses. The method includes screening for and identifying high performance businesses for a universe of businesses from a plurality of industries, and determining industry drivers for the identified high performance businesses in each of the industries. The method further includes synthesizing the determined industry drivers to adopt a high performance business framework. This high performance business framework defines a plurality of discipline characteristics common to the known high performance businesses as the intersection of a plurality of building blocks with a plurality of discipline types. The methods further comprises diagnosing the gap between a subject company and the identified high performance businesses according to the high performance business framework, where the diagnosing includes performing assessments for each the building block. The method further includes linking diagnosed gap areas affecting the subject company with a set of known solutions particularly adapted for improving the gap areas, and initiating and managing one or more of the solutions to emulate the decisions, practices, or mindsets of the known high performance businesses.

The various embodiments of the invention having thus been generally described, several illustrative embodiments will hereafter be discussed with particular reference to several attached drawings.

### BRIEF DESCRIPTION OF THE DRAWINGS

FIG. 1 is flow diagram showing a high performance business emulation process for establishing and utilizing a high performance business framework according to an embodiment of the present invention.

FIG. 2 is a schematic diagram of a high performance business framework according to an embodiment of the present invention.

FIG. 3 is an illustration of a performance ranking chart that may be utilized in certain embodiments of the present invention to identify high performance businesses within a given industry.

FIG. 4 is an illustration of a diagnostic testing summary report that may be utilized in certain embodiments of the present invention to demonstrate how a subject company compares with high performance businesses within a given industry.

FIG. 5 is a chart depicting how sample key questions may map to discipline types and discipline characteristics in the market focus and position building block according to certain embodiments of the present invention.

FIG. 6 is an illustration of a sample diagnostic scorecard that may be utilized in certain embodiments of the present invention to depict how a subject company compares with high performance businesses within the market focus and position building block according to certain embodiments of the present invention.

FIG. 7 is a chart depicting how sample key questions may map to discipline types and discipline characteristics in the distinctive capabilities building block according to certain embodiments of the present invention.

FIG. 8 is an illustration of sample questions and format utilized within an executive level diagnostic for the distinctive capabilities building block according to certain embodiments of the present invention.

FIG. 9 is an illustration of a sample executive level diagnostic scorecard that may be utilized in certain embodiments of the present invention to depict how a subject company compares with high performance businesses within the distinctive capabilities building block according to certain embodiments of the present invention.

FIG. 10 is an illustration of a sample service line mastery scales that may be utilized in certain embodiments of the present invention to depict how a subject company compares with high performance businesses within the distinctive capabilities building block.

FIG. 11 is a chart depicting how sample key questions may map to discipline types and discipline characteristics in the performance anatomy building block according to certain embodiments of the present invention.

FIG. 12 is an illustration of a sample organizational assessment score report produced from the organization performance assessment executive that may be utilized in certain embodiments of the present invention to depict how a subject company compares with high performance businesses within the performance anatomy building block.

FIG. 13 is an illustration of a sample performance anatomy index that may be utilized in certain embodiments of the present invention to depict graphically how a subject company compares with high performance businesses within the performance anatomy building block.

### DESCRIPTION OF THE PREFERRED EMBODIMENTS

Embodiments of the invention include processes for establishing and utilizing a high performance business framework according to an embodiment of the present invention. The framework, as utilized in the emulation process, provides a tools for identifying how a subject company, business venture, or other entity of interest compares to high performance businesses by establishing qualitative and quantitative metrics for the various discipline characteristics across the three main building blocks of a high performance business, namely, market focus and position, distinctive capabilities, and performance anatomy, and by establishing diagnostics for accessing such metrics. This, in turn, provides informative and valuable information regarding the financial performance of a target business entity and their competitors that can be used in making strategic decisions and forecasts.

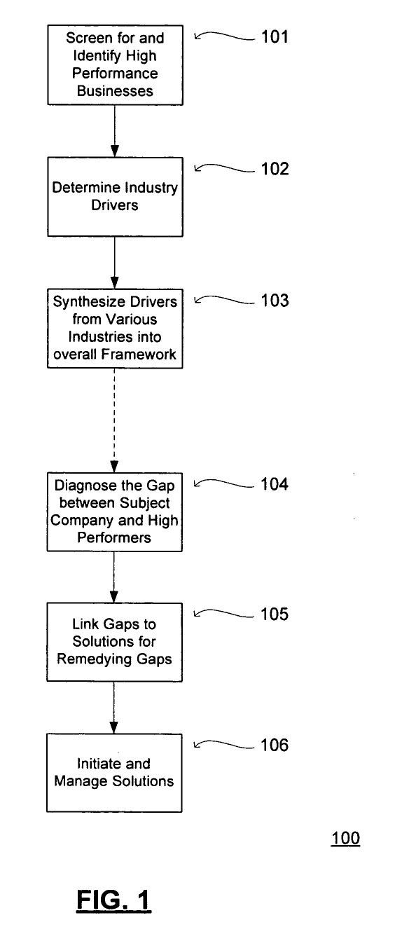

Referring now to FIG. 1, there is depicted a flow diagram of a process utilized in preferred embodiments of the present invention to establish high performance business frameworks and associated diagnostics, and to utilize such diagnostics within the framework to help managers of businesses emulate the characteristics of high performance business. The high performance business emulation process 100 depicted in FIG. 1 is intended to assist one of ordinary skill in the art in understanding the interrelation of various components of the framework and associated diagnostics of the present invention. It will be appreciated by those of ordinary skill in the art that, while indicated as being sequential, the particular steps depicted and described so as to be generally illustrative only and, where apparent, the process can be varied without departing from the spirit of the invention. Thus, the steps can be performed in overlapping or simultaneous fashion, when convenient or desirable. Further, while not explicitly depicted, it will be understood by one skilled in the art that various ones of the steps could be repeated as new data is obtained.

As will become apparent after the following detailed description of FIG. 1, high performance business emulation process 100 can be thought of as having a research phase consisting mainly of steps 101-103, and an execution phase consisting mainly of steps 104-106. Understandably, steps 103 and 104 of process 100 are depicted as being separated by a longer dotted arrow, which is intended to illustrate the temporal delay between steps 103 and 104 and these two phases.

The set up phase comprises the various preparation steps taken to establish a high performance business architecture as described herein, and starts at step 101 with the screening of financial data to identify high performance businesses. It should be readily appreciated by one skilled in the art that whether a particular company or business is characterized as a high performance business is, of course, dependent upon one's definition of high performance. Preferably, such screening is performed within appropriate peer groups to cover different industries.

Step 101 comprises a detailed study of a universe of financial and other data concerning companies in various industries and markets. A screening of those companies is then employed to identify business entities that qualify according to an established criteria as high performance businesses.

Because the definition of “high performance” adopted in the present invention involves the enduring or sustained outperformance of peers, across business and economic cycles, often across generations of leadership, and as measured by widely accepted financial metrics, identification of high performance businesses as depicted in FIG. 1 focused on identifying those business entities that sustained business excellence. One of ordinary skill in the art will recognize that giving due consideration to sustained outperformance is important when identifying high performance businesses. Many companies can appear to be high-performance businesses in the short run—by riding favorable market conditions, for example, or by being fortunate with a single product or market position, only to decline quickly when business conditions turn against them. To be a true high performer, a company must survive, and thrive, across discontinuities, requiring leadership that consciously manages for today and tomorrow.

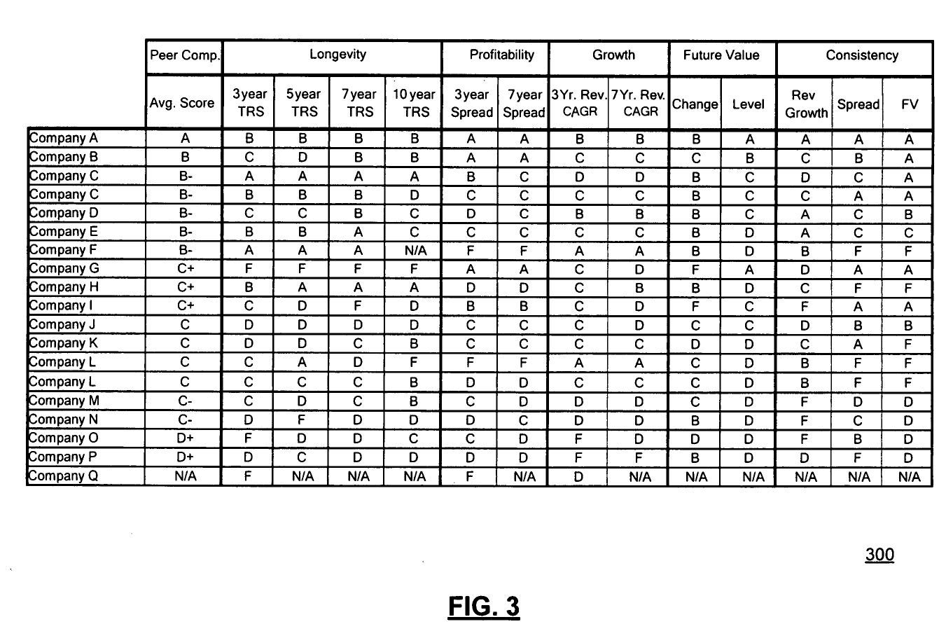

While each measure has one or more core metrics associated with it, such as five-year total return to shareholders, the unique characteristics of individual industries can require adding more metrics to the measures, to ensure a proper understanding of that measure within that industry. In preferred embodiments of the present invention, five main financial areas may be researched at step 101 to identify high performance businesses that have demonstrated sustained performance. These five main areas include: growth as measured by revenue expansion; profitability as measured by the spread between the return on and cost of capital; positioning for the future as represented by the portion of share price that cannot be explained by current earnings, and by the portion of the industry total each company's “future value” represents; longevity as measured by the duration or track record of outperformance in total return to shareholders; and consistency as measured by the volatility or the dispersion of that performance over time. For these five main areas, a measure of peer competitiveness can thereby be generated, such as by creating a composite of relative scores for the first five factors. This methodology is particularly suitable to showcase the high performers, and also highlights that all performance is relative. Changes to the peer set, for example by rejecting some competitors because they are too small or too big, will almost inevitably change the performance as you have changed the expectations. FIG. 3 depicts an example of a performance ranking chart 300 that may be utilized in certain embodiments of the present invention to identify high performance businesses within a given industry. Chart 300 is one suitable output of such comparisons that may be used to rank and compare various financial metrics that may be used when identifying high performance businesses at step 101. Notably, such performance ranking charts can of course take on a variety of forms. For example, scatter plots and other graphs may be used to graphically depict the data of various companies within the subject peer group. Furthermore, actual raw financial metrics data (such as spread scores and the like) as opposed to benchmarked scores (such as graded levels “A“-”F” as depicted in chart 300) may be produced in such graphs.

Returning again to FIG. 1, high performance business emulation process 100 continues at step 102 with the determining of industry drivers from the high performance business data screened at step 101. Understandably, such drivers typically would vary on an industry by industry basis.

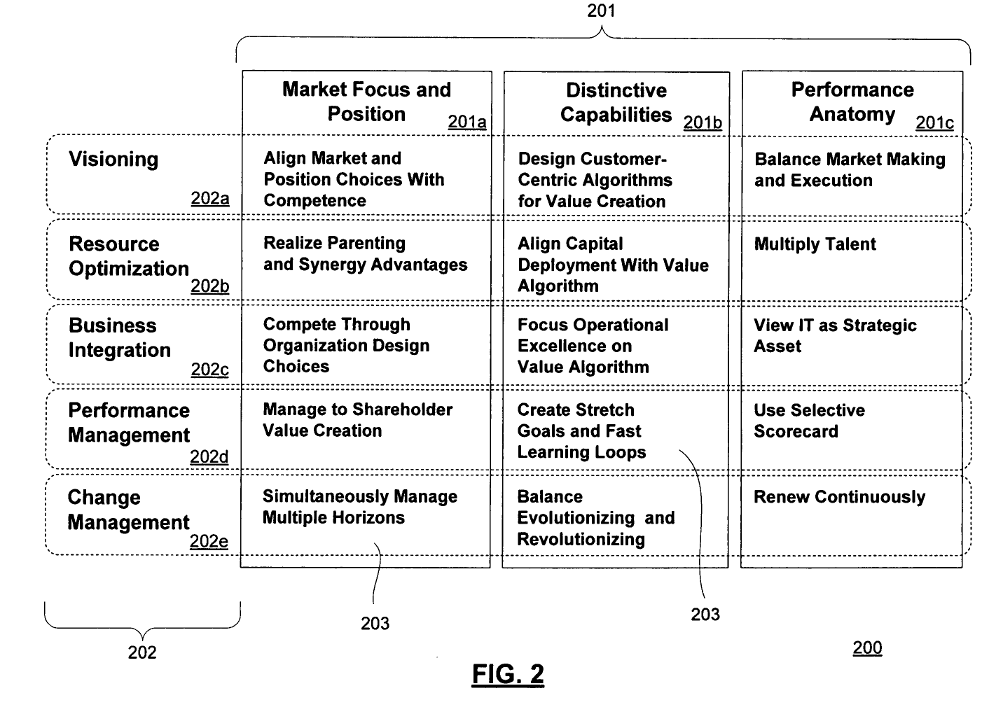

The research phase of process 100 concludes at step 103 with the synthesizing of drivers from various industries into an overall high performance business framework. In utilizing the process 100 according to preferred embodiments of the present invention, the preferred high performance business framework 200 as depicted in FIG. 2 is established.

Turning now to FIG. 2, it is seen that there are identified three core building blocks 201 (also individually labeled 201a-201c) through which five discipline types 202 (also individually labeled 202a-202e) traverse. The building blocks 201 and discipline types thus form by their intersection five different disciplines characteristics for each building block (discipline characteristics generically being designated as 203 in FIG. 2). In framework 200, the five discipline types 202 intersect with each of the three building blocks 201 to define fifteen discipline characteristics (five for each building block) that are highly indicative of high performance businesses when the components of each building block are analyzed. This framework, as will be described in detail hereafter, can be utilized in the execution phase of steps 104-106 to link specific industry drivers to the key building blocks.

No one attribute or discipline characteristic can give a company a building block of a high performance business, but together, however, these five consistently make the difference between business practices that are good but unexceptional, and those that make a real and lasting difference in company performance. An examination of each of the five discipline characteristic elements of a building block reveals how companies actually build them, and what other companies must do to find their own path to achieving them.

The five disciplines types were identified as visioning 202a, resource optimization 202b, business integration 202c, performance management 202d, and change management 202e. The market focus and position business building block 201a reflects the parts of a high performance business that maximizes growth opportunities and structural economic advantage. Similarly, the distinctive capabilities building block 201b maximizes competitive differentiation for high performance businesses, while the performance anatomy building block 201c reflects a high performance business's attempts to out-execute the competition.

As shown in the framework 200 of FIG. 2, the first discipline characteristic for the distinctive capabilities building block 201b formed by the intersection with discipline type 202a (i.e., visioning) concerns whether the business entity has designed customer-centric algorithms (i.e., a unique formula) for value creation. The second discipline characteristic, formed by the intersection with discipline type 202b (i.e., resource optimization), concerns whether the entity aligns its capital employment with its value algorithm such that its major investments enable their value creation formulas. The third discipline characteristic, formed by the intersection with discipline type 202c (i.e., business integration) as depicted, assesses whether business entity focuses operation excellence on its value algorithms by concentrating on linking core processes together. The fourth discipline characteristic, formed by the intersection with discipline type 202d (i.e., performance management), relates to whether the entity creates “stretch goals” and fast learning loops to ascertain whether it appropriately uses lofty and balanced goals without forcing tradeoffs, while the fifth discipline characteristic, formed by the intersection with discipline type 202e (i.e., change management), relates to whether the entity is successfully balancing evolutionizing and revolutionizing of its capabilities.

Applicants' analysis has discovered that high performers balance their focus on market strategy with a commitment to creating and exploiting a set of distinctive, hard-to-replicate capabilities that deliver the promised customer experience, while simultaneously driving the most efficient utilization of assets.

For capabilities to be truly distinctive, these two objectives must be synchronized. While many companies have mastered either the customer experience or excellent asset utilization, high performers create capabilities that are totally aligned with, and that most efficiently serve, a clearly defined customer experience. High-performance businesses understand the need to build such distinctive capabilities—ones that are demonstrably better than their competitors' and, in the short term at least, inimitable. Distinctiveness, as defined herein, arises not through excellence in a single functional silo but through the combination of mastery in a large number of individual capabilities.

The third essential building block of competitive essence is a focus on the creation of a high-performance anatomy. Distinct from culture and organization design, high-performance anatomy comprises a set of organizational “mindsets.” These mindsets drive important differences in behavior, including by individual employees on up to those of the company itself, that lead to better business outcomes. Significantly, these mindsets are immediately actionable by an organization's leadership. It is believed that these mindsets that empower companies in their goal of out-executing the competition.

As shown in the framework 200 depicted in FIG. 2, the first discipline characteristic for the market focus and position building block concerns whether the business entity in question aligns market and position choices with competence, such that the entity puts its focus (and thus eventually resources) behind winning capabilities. The second discipline characteristic concerns whether the entity realizes parenting and synergy advantages, such as by appropriately leveraging its management and resources. The third discipline characteristic concerns whether the business entity competes through organization design choices by making its organizational structure align with its business strategies. The fourth discipline characteristic relates to whether the entity manages to effect shareholder value creation, and the fifth relates to whether the entity simultaneously manages multiple time horizons to plan and create value for the future while also taking full advantage of present opportunities.

The first building block reflects a company's capacity for maximizing growth opportunities and structural economic advantages. High performers understand the dynamics of their industries better than their competitors do, and they successfully manage the creation of value through appropriate strategies. Every company has some level of appreciation for the contribution and value of good strategy. But what sets high performers apart is how they perceive the role of strategy, and what they see as the best means for creating it.

Even in today's complex, dynamic world, where deliberate strategy is considered less relevant, high-performance businesses take the art of strategy very seriously.

For these companies, it is not an ivory tower concept but a living component of their organization, understood and acted upon at all levels. High performers achieve remarkable clarity when setting strategic direction, especially regarding big decisions.

Yet they approach strategy execution as a series of hills to be surmounted, carefully rethinking their strategy at each hilltop, as the view of the battle and unanticipated opportunities, threats and challenges becomes clearer. Enabling these routine adjustments is the high performer's possession of management systems that are geared to producing acute insight.

High performers also maintain a strong capability-based perspective in their strategies, which they demonstrate in a common market-maker mindset. They seek not just to serve markets but to create them. Such strategies ultimately create value by enabling high performers to identify and forcefully enter attractive markets; to build and manage powerful portfolios; to exploit certain advantages of positioning in the value chain; and to achieve optimal scale.

The successful execution of each of these strategies has created powerful advantages for any number of leading companies. However, high performers recognize not only the advantages of such strategies but also their ultimate limitations.

The managing of time horizons for the change management discipline type 202e for the market focus and position building block 201a in framework 200 identifies that high performance businesses have a discipline characteristic that they manage multiple horizons simultaneously. High performance businesses manage both for today and tomorrow. For high performers, good choices are rooted not only in their present capabilities but also in those they can readily develop. The ability to make the right decisions in this dimension is also based on a company's skill at managing, often simultaneously, across near-, medium- and long-term time horizons.

High-performance businesses, by definition, achieve success over the long term. They balance the energy needed to succeed under today's market conditions with the energy needed to identify and forcefully enter new markets. Mergers and acquisitions are still part of many companies' strategic toolkits, but achieving high performance solely through acquisitions is a rare occurrence. Applicants have discovered that high performers maintain a constant emphasis on organic growth, at every level of scale and industry maturity.

Maintaining organic growth over time, however, is not easy. Deciding to broaden a company's scope into new businesses, or to increase its reach into related markets or new geographies, must be based on intelligent assessments of numerous factors. Yet in high performers, a characteristic wisdom to filter their opportunities, before making a decision, constantly and carefully through two important screens is seen.

Every high performer is driven by a winning vision, however, they can be called “realistic dreamers.” They push themselves to the limits of their capabilities, but not beyond. Every organization has a sort of frontier of “doability” in its strategy and visioning, and high performers have an intuitive sense of where that frontier lies. This is not to say high-performance businesses are passive when it comes to the innate capabilities that drive their vision. Today's frontier of doability does not have to be tomorrow's. High performers are always looking to build their competencies in ways that can propel them forward to new and higher ground.

Some of the hardest decisions executives make are about entering markets or creating businesses aimed at one day replacing or augmenting their existing businesses or capabilities. But that is exactly what high performers do to avoid being overtaken by competitors and disruptive technologies.

With regards to multiple horizons, as used herein Horizon 1 can be used to refer to core businesses that most observers would say define the company, while Horizon 2 refers to emerging growth businesses that first feed off of and then eventually replace Horizon 1 businesses as their sales and profits dwindle. Horizon 3 businesses are speculative and visionary—businesses that may not pay off for 5 to 10 years, or longer.

High performers make decisions that actively implement an overall strategy across all three horizons, even when those decisions require enormous additional investments that threaten to cannibalize their existing businesses. The secret of high performers is funding new businesses from the profits of cash cows when they are richest, not waiting until such funds have dried up.

The key to capitalizing on all types of horizon opportunities is recognizing that each horizon requires a different style of decision making. Businesses on different horizons may require different organizational structures, for example. Companies cannot try to force-fit a design that works at a mature Horizon 1 company into a speculative Horizon 3 company, which may require looser reins and more entrepreneurial, risk-embracing leadership. High performers know how to balance and move forward with a complex array of different types of leaders, rewards, measurements, reviews and investment levels, depending on which horizon they are managing.

What is very important in making Horizon 3 decisions, however, is having the ability to effectively target a moving object. High performers aim at where the money is going to be, not where it is at the moment. They anticipate market moves and demographic trends, and create what customers will want in the future, not just what they want now.

When making a bet on the future, however, high performance businesses are wary of two traps. The first—assuming your company is the only one to see an opportunity five or more years out—can lead to disaster. For example, so many companies saw the growing demographics-driven opportunity in senior housing that many of the successful early entrants eventually were driven into bankruptcy by a slew of competitors right on their heels. High performers base decisions about new markets not only on consumer and product trends but on competitor trends as well. They decide whether they truly have the appetite to see the game through and do whatever it takes to win, and they maintain a viable exit strategy in case their position irrevocably weakens.

A second trap involves riding a strong horse for too long. Following along with a market segment as it ages can lead companies to a dead end. By making a product that is continuously successful only with its core customer segment, a company can drive a brand or business line into obsolescence.

For the resource optimization discipline type 202b, the discipline characteristic of high performance businesses for the market focus and position 201a building block entails realizing parenting and synergy advantages. How to best “parent” the businesses they operate. High performers choose highly distinctive value-added activities for their corporate cores, and then build or acquire a set of businesses uniquely able to benefit from the core and the other business units.

If one observes a healthy tree, they will notice that not only does it have a strong trunk that supports its branches, but the branches are positioned in a manner that maximizes the absorption of the energy the tree needs to grow. High-performance businesses achieve success through an analogous parenting-and-synergy capability.

They make good decisions that optimize their resources based on the unique qualities of both parent and child. First, they carefully choose the right businesses for their portfolio. Next, they select the right parent resources with distinctive strengths, and then leverage those strengths all through the organization.

The strengths parent companies choose to leverage with their business units are not always tangible ones, however. Success can be built in part on sharing a strong culture-delivering distinctive and hard-to-imitate advantages that are based on its core belief system. For example, when contemplating an acquisition, such a company could weight the likelihood of the new entity adopting this distinctive culture.

Good parenting is serious business for high performers. They don't take a “bare minimum” or perfunctory approach that says parenting is only about supervision or shared services. Their executives are active leaders and drivers of change. Unlike average companies, high performers derive significant real competitive advantages from their corporate centers, and do so by design.

High performers know that what their businesses need from a parent changes with the maturity of the business and its industry lifecycle, the changing structure and nature of the portfolio, and external events and disruptive technologies. Because of constant changes in competitive circumstances, the acid test of parenting for high performers is not whether the core is adding value but whether it is still adding more value than an alternative parent company could. Many mega-mergers are touted as mergers of equals before they implode, highlighting how a failure to appreciate the important value of parenting to the success of merged companies can lead to disaster.

For the business integration discipline type 202c, high performance businesses must compete through organizational design choices under market focus and position building block 201a. The best companies develop unique designs and leadership structures that reinforce their chosen sources of competitive advantage, rather than follow a formulaic design process from a textbook.

Through the market focus and position building block 201a of framework 200, high performers achieve a kind of strategic decision-making capability that enables them to compete in the best markets and maximize growth opportunities, without reaching or scaling beyond their limits; to select and manage the optimal portfolio of businesses; and to use organization design as a competitive weapon. Behind every brilliant strategic decision that gives a company the right market focus and position lies a series of smaller decisions along each of these three dimensions.

High performers also have a distinctive attitude when it comes to organization design, the discipline characteristic formed by the intersection of the business integration discipline type 202c with the market focus and position building block 201a as depicted in FIG. 2. They know that a design should reflect already-existing strengths and energies of people in the business, and they use a deep knowledge of their people to create the design that's right for their company. They know what the textbooks say, but they also know that following someone else's standard of organization design can limit a company's ability to compete in a differentiated way. The organization design of a high-performance business avoids rigidity, and it actively serves the needs of its businesses on multiple horizons.

The drivers linked to framework 200 recognize that organization design choices can vary significantly between high performance businesses in the same industry. There are no “right” answers to questions regarding whether, for example, procurement should be managed globally or regionally, or whether functions like HR and finance should be controlled at the local or regional level. High performers know their strength lies not in the labels on the organization chart but in the unique ways their organizations are able to execute that design.

High performers do not create differences just for difference's sake, however. One particular way these companies differentiate their organization design is by creating signature processes. Unlike best-practice processes, signature processes create distinctive advantage because they have grown as the company has grown, and are intimately connected to the passions of the executive team.

Organization design can remain a competitive advantage only if it evolves with the business and its environment—by freeing imprisoned resources through continual reorganization and by breaking orthodoxies and mindsets that become rigid in the absence of change. Many once-great businesses are in trouble today, in the retail and airline industries, for example, not because their organization design wasn't once great but because the design was not a living one. The design did not change when the environment did.

High performers recognize, however, that organization design must support the company's ability to successfully operate businesses aimed at all three strategic horizons. Units at different stages of industry and business maturity require significantly different levels and types of resources and incentives. The discipline characteristic formed by the intersection of the change management discipline type 202 and the market focus and position building block 201a recognizes that high performance businesses tend to have organization designs with multiple parts to support those distinct businesses and their distinct needs.

The first discipline characteristic depicted in the framework 200 of FIG. 2 by the intersection of the visioning discipline type 202a within the distinctive capabilities building block 201b is the design and use of customer centric algorithms. Companies with distinctive capabilities define customer-centric algorithms for value creation. All companies recognize the need to serve customers well. However, a high performer relies on an algorithm that charts the path from process to profit to achieve a sustainable advantage.

A business algorithm is a formula for doing business, either at the enterprise or business unit level, that translates a big idea regarding customer needs into a specific set of connected business processes and resources that cost-effectively satisfy those needs. The result is significant value for customers and shareholders.

There are two crucial elements to creating a successful algorithm. The first is deep insight into what consumers truly value (or will value) in an offering category, and an understanding of the marketing capabilities, such as building the branded experience, are necessary to create and sustain demand. The second is originality in identifying the most profitable configuration of resources to deliver the promised value. Such originality can come only from deep knowledge and mastery of a range of capabilities, from finance to supply chain to human performance.

For example, a leading auto insurer formulated its algorithm after recognizing that what many customers value in auto insurance—and the main factor in customer retention—is fast claims payment. The company leveraged new technologies to link a number of processes so that most customers receive the settlement check on the spot, immediately after the claims adjustor has inspected the damage, and not weeks later. The result being dramatic business growth and an actual reduction in the ratio of costs to claims.

Creating a successful algorithm is never easy. It requires deep insight into customers' current and future needs, and it demands the creative use of resources to manage the costs of delivering exceptional value. Yet the high performers are characterized in that they understand, across a wide range of employee levels, the unique value-creation process that enables them to make money, and that is, in essence, the formula for their success.

The second discipline characteristic, which results from the intersection of the resource optimization discipline type 202b within the distinctive capabilities building block 201b reflects the fact that high performance businesses align their capital deployment with these algorithms. A key to making a distinctive capability work is ensuring that capital deployment is disproportionately targeted to the underlying business algorithm. At a minimum, this means each component process has the financial backing it needs to be successful.

This kind of commitment can be substantial. A major implication of this discipline characteristic is that annual budgeting versus zero-based budgeting can lead to the misappropriation of funds to areas that, as the core processes in the algorithm change over time, no longer create substantial value.

Core processes in high performers not only get adequate financial support. They also tend to receive the greatest focus on human capital, from management on down to line employees. A CEO's provenance is often a strong sign of where a company's key algorithm processes are located. Another is the differentiated way a company treats the employees within key processes. High performers often devote special resources, including performance improvement efforts, to such employees.

Their generous funding of key processes does not mean that high performers ignore cost management. Indeed, high performers are often fanatical about asset efficiency, and they use asset innovation as a key component in their algorithms. The companies seek advantage not just from high margins but, wherever possible, from a high return on net assets, creating a low-cost structure that can sustain a first mover in the face of copycat competitors.

Today's low-cost carriers in the airline industry, for example, have innovated to create greater returns from both their fixed assets and their workforces—a powerful one—two punch of capabilities. First, these companies invested in a uniform fleet of aircraft, usually Boeing 737s, eliminating the increased maintenance and operating costs associated with a mixed fleet. Next, they make the most of their human capital by having employees work in multiple roles: They not only assist passengers in-flight but also clean the cabin and, upon landing, frequently serve as additional gate agents. Together, these reduced asset costs help these carriers maintain their powerful low-cost, high-customer-value position against the major carriers. However, it is important to note that while high performers seek a substantial return on assets, they are extremely careful not to go too far and embrace capital deployment models that are highly productive in theory but that cannot or do not support a successful algorithm.

The second discipline characteristic, which results from the intersection of the business integration discipline type 202c with the distinctive capabilities building block 201b, is that high performance businesses concentrate their operational integration efforts on the core processes of these algorithms. Operational integration, while a common buzzword, is an important part of what makes the capabilities of a high performer distinctive. While many companies struggle to integrate all of their processes, building ever larger interconnected webs of information sharing (usually with mixed results), high performers focus their integration efforts. They make a substantial investment in integrating only what truly matters to their business algorithm—they don't try to connect everything to everything else.

Creating the right integration in the snack food business is one example. One company's value algorithm is focused on freshness, so speed from its kitchens to store shelves is critical. The company achieves this goal through a direct store delivery model that tightly couples production with delivery systems; it also uses delivery employees as sales personnel.

The system makes the consumer happy by putting fresh products on the shelves and by limiting out-of-stocks, while also making the company's profit equation work better. By increasing the speed to the shelf, the company dramatically improves the return on its production and delivery assets, and nearly eliminates warehousing costs. Even better, its model is one competitors have found hard to duplicate.

Though it is counterintuitive, to make an algorithm work, some of the individual parts must deliberately not be optimized. For example, spare capacity in its production and distribution systems can be used to meet “velocity goals,” which benchmark the speed at which new items are delivered to stores.

Furthermore, optimal product innovation can be sacrificed to stay true to a business algorithm focused on low prices and volume sales. For example, to avoid disrupting its continuous flow production model, a company could modify one new item to make it less complicated to manufacture, despite the fact that testing revealed this would make customers like the product less. This company, as a high performer, could realize that its success does not depend on product innovation. Instead, the company's business algorithm could be based on delivering high volumes at the low prices such volume enables, which, in turn, keeps demand high.

The fourth discipline characteristic of high performance businesses, which results from the intersection of the performance management discipline type 202d with the distinctive capabilities building block 201b, is that they continuously improve their algorithms' performance through stretch goals and fast learning loops. If a company is to succeed in today's highly competitive marketplace, its business algorithms require continuous improvement. The company must quickly move along the learning curve, increasing barriers to competition, improving cost structures, and enhancing the fit of its offerings to customer needs by effectively capturing and acting on customer insights.

High performers achieve this first by continually setting stretch goals for their organizations, especially for the core processes of their value algorithm, and then by employing fast learning loops—auxiliary processes that quickly transform insights about how to improve into actions that result in improvement. This enables them to achieve what can be called “stretch learning,” the ability to gain the knowledge necessary to improve not just incrementally but dramatically.

High performers understand that management cannot dictate the solutions that allow them to achieve true stretch goals. To encourage stretch learning, goals must appear unattainable. Meeting those “impossible” goals can then occur through rapid and creative collaboration involving employees of all levels, outside experts and business partners. Because reaching stretch goals is about more than simply increasing labor, the goals are sufficiently aggressive only when they force employees to work smarter, not harder.

High performers often base their fast learning loops on better measurement processes. Further, high performers are able to achieve stretch learning because they better understand their progress along individual learning curves. Similarly, they are better able to move on to new learning curves as the current one flattens—but before it bottoms out completely. For example, a manufacturer could achieve this by effectively designing new performance improvement programs each time it notices that its measured productivity improvement is slowing, effectively creating a continuous series of step-change improvements in productivity.

The fifth and last discipline characteristic within the distinctive capabilities building block 201b, which results from the intersection of the change management discipline type 202e, is that high performance business maintain a balance between evolutionary and revolutionary change as capabilities and algorithms are inevitably adapted. Distinctive capabilities must be dynamic, because at their heart they rely on customer insight, which requires them to be responsive to ever-changing customer needs. Beyond that they must also respond to the demands of environmental change and technology disruption.

High performers are particularly good at both adjusting their algorithm and redefining it when circumstances require them to. Applicants have found that high performers achieve the right balance—knowing when an algorithm must evolve and when change must be more revolutionary. Many companies fail because they gave up on an algorithm too soon or because they held onto an algorithm too long.

One manner by which high performers maintain this right balance is to move quickly and continuously to acquire the new capabilities needed to adapt their algorithm to changing market conditions. Another way high performers successfully preserve their algorithm is by refreshing its component capabilities when the algorithm is faltering but not yet failing. For example, rapidly growing labor costs due to high attrition may increasingly challenged the staffing component of its successful algorithm based on low cost, high volume sales. Knowing that an emphasis on selling low-priced items may preclude increasing wages across-the-board, a company may set out to reduce attrition by investing in more selective hiring, better training and greater incentive-based compensation for its managers.

As shown in the framework 200 of FIG. 2, the first discipline characteristic for the distinctive capabilities building block 201b formed by the intersection with concerns whether the business entity has designed customer-centric algorithms (i.e., a unique formula) for value creation. The second discipline characteristic, formed by the intersection with discipline type 202b (i.e., resource optimization), concerns whether the entity aligns its capital employment with its value algorithm such that its major investments enable their value creation formulas. The third discipline characteristic, formed by the intersection with discipline type 202c (i.e., business integration) as depicted, assesses whether business entity focuses operation excellence on its value algorithms by concentrating on linking core processes together. The fourth discipline characteristic, formed by the intersection with discipline type 202d (i.e., performance management), relates to whether the entity creates “stretch goals” and fast learning loops to ascertain whether it appropriately uses lofty and balanced goals without forcing tradeoffs, while the fifth discipline characteristic, formed by the intersection with discipline type 202e (i.e., change management), relates to whether the entity is successfully balancing evolutionizing and revolutionizing of its capabilities.

As depicted in FIG. 2, the research into high performance businesses as described above defined a preferred framework 200 that provides the following discipline characteristics that are key to creating a high-performance anatomy. First, execution excellence and successful market creation must be balanced, as indicated by the visioning discipline type 202a. Second, talent and its impact should be multiplied to make workforce productivity a key execution differentiator, as indicated by the resource optimization discipline type 202b. Third, IT should be viewed by the business entity as a strategic asset, as indicated by the business integration discipline type 202c. Fourth, a selective scorecard must be used so that performance measurement must is broadly inclusive yet highly selective in its focus and metrics, ad indicated by the performance management discipline type 202d. Fifth and finally, continuous renewal is a real and permanent necessity within a high-performance business, as shown by the intersection of the change management discipline type 202e.

Applicants have found that whether or not these mindsets are pervasive within a company has a profound impact on its performance. A continuous renewal mindset, for example can be used to ensure the company is informed at every level about what it needs to be successful. Customer satisfaction scores are posted daily, and individual incentives for example can be built around customer satisfaction, keeping the focus on ongoing, value-creating change. Successfully establishing all of these mindsets requires alignment, both across the various mindsets as well as across the other building blocks.

Performance anatomy runs deep inside an organization, and it affects all of its employees and functions. Performance anatomy is neither hereditary nor accidental. It is the outcome of deliberate choices made by senior executives. Yet it is also by nature elusive, rarely if ever reducible to a concise or canned statement of vision and values.

Performance anatomy differs from conventional concepts of corporate culture in several key ways. Performance anatomy is similar to culture in that it expresses the vision and values of the organization—especially those of the founders. But it is different as defined according to the present invention in that it contains very clear and explicit directions for how each of those core elements ought to be managed and what competencies the organization needs to develop to achieve high performance.

Additionally, performance anatomy represents a distinctive perspective on the interaction and the integration of those core elements. In particular, performance anatomy demonstrates how and why these elements relate to one another the way they do. High-performance businesses have identifiable characteristics across five disciplines and within three building blocks that enable them to manage actively the interaction between leadership and strategy, people development, IT enablement, performance measurement and innovation in a way that produces outstanding and sustainable results. Alternatively, conventional treatments of culture provide little insight into how companies manage these interactions.

Further, CEOs and their top management teams make integration of those elements a primary responsibility, whether they do it intuitively or programmatically. Indeed, the ability of a top management team to build the organization's performance anatomy actively is testimony to its deep understanding of the competitive essence of the business. Performance anatomy thus represents more than values and assumptions. It represents a touchstone guarded and stewarded by the CEO that aligns the top management team—a touchstone that is absolutely essential in an increasingly turbulent and uncertain business environment.

Like the other building blocks 201 of FIG. 2, the impact of performance anatomy is profound. It touches decisions about organization design, business models, incentives and values, and top management team composition and succession; it affects the long-term effectiveness, quality and speed of decision making, as well as the mastery of change and innovation productivity.

The challenge of creating a high-performance anatomy is considerable because executives must commit to decisions and actions that may produce only subtle changes in the short term, even if they will have enormous impact years later on the company's ability to outperform competitors and fend off new entrants. In too many businesses, the agenda gets swamped by the pressing needs of operational realities.

The visioning discipline characteristic for performance anatomy involves the mechanisms, whether through leadership or strategy, by which a business entity goes about to balancing a market-maker mindset with disciplined execution. Many of today's leading business books underscore the importance of the intellectual underpinnings of a business's pursuit of growth. Others have focused on the importance of “execution,” namely, the ability to act as well as think. High performance companies do both. They shape markets based on an unrelenting pursuit of customer-valued innovation. Such companies have worked hard to get close to customers and identify latent demand. High-performing companies are not merely reacting to market evolution.

Yet these companies also maintain a discipline in their ability to execute that is the envy of their competitors. They value and believe in organizational discipline—in the kind of adherence to budgets and deadlines that creates mutual reliability and trust within and throughout organizations. They have made a commitment to commitments, if you will. In the process, they successfully manage the paradoxes of near- and long-term business focus, including the requirement to create both lasting stability and constant change, both management control and organizational flexibility. They actively embrace stretch goals but are not reckless with what they have already established.

The resource optimization discipline type 202b defines within the performance anatomy building block a requirement that high performance businesses use talent-multiplier systems that permit them to make the best out of people resources. Specifically, high performance businesses prove more effective than their competitors at exploiting the collective intelligence and motivation of their workforces. One reason is that there is a strong correlation between financial performance and the priority organizations place on human capital development. For example, leading companies are far more likely than others to regularly measure the link between investments in people and business results. Moreover, their CEOs take a much more visible and direct role in people-development initiatives. In this way, high performers create a “talent multiplier”—better results per dollar of investment in their workforces. This multiplier serves as a real and hard-to-imitate competitive advantage.

Building a talent-multiplier system requires a fundamental shift in mindset, followed by changes in several key human performance areas. This mindset is one in which human capital development is considered strategic. Rarely is this shift accomplished by simply elevating conventional human resources executives to the executive suite. Indeed, in more than one instance, we found that high-performance companies drew their HR executives from outside the HR community, and when they could not be found inside the company, outside experts were brought in to advise the CEO.

When building a talent-multiplier system, among the most important changes in HR processes are those involved in identifying talent, preparing leaders and supporting the optimal performance of the workforce. Research often suggests two effective ways to identify next-generation leaders: Find people who already have the “right stuff,” or find people with extraordinary learning capacities, even if they're not ready to lead right away.

Many companies pay lip service to these approaches, or apply them superficially. But a high performer identifies talented employees early in their careers, grooming them with developmental experiences that are increasingly strategic in focus and enterprise-wide in scope, and providing them with coaching and learning through successes—and, if necessary, failures.

High-performance businesses also excel at a second and tougher task: recognizing underperforming employees and dealing with them decisively. Knowing that discipline in small things leads to discipline in big things, these companies strive to stay on top of employee underperformance, nipping the weed-like spread of slipshod work in the bud.

At many companies, preparing employees to lead simply means having a clear succession plan, and mechanisms in place to identify and harness talent. High performers do things differently. Their perspective is much broader, enabling them to tap into the abilities and leadership of a larger pool of potential talent. Just as an army develops effective leadership for frontline duty, not just at central command, high performers build leadership in depth, focusing not just on getting those with high potential up to speed quicker but also on making B players better.

The benefits of better selection and preparation, however, can be diminished if employees find themselves working in an environment that does not fully champion their success. Workplace design can be strongly correlated with both innovation and financial performance. The full talent-multiplier effect is driven by an additional focus on performance support, evinced in subtle yet important cultural behaviors, such as tolerance for risk and failure, flextime, job sharing and creative contracting—all practices embraced by high-performing businesses that give their employees the support they need to be extraordinarily productive (and often to lower costs at the same time).

Many high-performance businesses also possess a cadre of self-organizing teams that encourage and enable talented workers to identify one another and collaborate.

A final aspect of establishing the right environment for developing talent is creating continuity and stability, which means not launching big CEO initiatives every year or every month. High performers are committed to consistent improvement, not continual drastic change, and they are characterized by a willingness to reap its benefits in a slow but steady pattern that allows every employee to be part of changing for the better.

The business integration discipline type 202c of framework 200 intersects with the performance anatomy building block 201c to define a discipline characteristic that states that high performance businesses view IT as a strategic asset through the utilization of technology enablement mechanisms. High performance businesses are characterized in that they regard IT as a source of both operational excellence and competitive advantage. They look beyond using IT as a tool for controlling costs, and understand that IT is the link for capturing the business value of information. However, the strategic use of IT demands far more than just a strategy and leading-edge systems. Top management must recognize that IT's true benefit is as an enabler of innovation and new value creation, and that this benefit will be realized only when employees use IT intensively and creatively. High performers imbue every employee and function with an understanding of the value of information technology for innovation and competitiveness.

For example, a company can organize IT implementations by business process, independent of the ultimate software application. This way, management reinforces a strong connection between business strategy and technology. To measure whether the company has embraced this mindset, executives track subtle but telling signs. For example, one may consider whether IT (as a function) is involved in the creation of business innovation (e.g., to what extent has it helped the company break out of the organizational silos?). Similarly, one may consider whether idea practitioners and corporate planners regularly attend technology and innovation conferences to keep abreast of emerging technologies. Further, one may consider if there is an ongoing process to assess and adopt new technologies as they become economical and scalable.

High performers experiment with more technologies than their less tech-savvy competitors. They may end up having to abandon some of their early adoptions, but their successes more often than not improve competitiveness and market impact. Through repeated assessment, experimentation and adoption of new technologies, these organizations are able to eliminate technologies that don't work.

High performers recognize IT's critical importance in creating business insights, customer insights, quality and innovation, in both products and services. For example, an open innovation environment can be used as a tool to encourage customers and partners to co-develop new markets and products. A balance of co-development and in-house development can be employed such that third-party technologies are not rejected as a matter of course, making the company able to see and act on the potential of technologies from both inside and outside the company.

Discovering ways to accelerate the conversion from data to information to business value through the strategic use of IT can make a company a high performance business.

The performance measurement discipline type 202d forms a discipline characteristic for the performance anatomy building block that describes how high performance businesses employ selective scorecards to measure tangibles and intangibles that are important to their value proposition. High performance businesses create value-centered cultures that permeate the entire organization. They recognize that future performance is dependent on resources that don't appear on a conventional balance sheet, and they incorporate intangible assets into practice, actively managing them by finding ways to assess the trade-offs between tangible and intangible investments. Such businesses not only establish disciplined performance measurement for today's widely recognized intangible assets, such as talent, know-how and brand, but also create and measure intangibles that are specific only to the values of their organization.

Engaged, involved and committed employees not only strive to make the best possible use of existing resources, they also seek out the skills and knowledge necessary to be effective—to do the work, to improve the way the work is done, and to revolutionize the work. This mechanism for assessing and valuing employee engagement and valued operational outcomes like safety, productivity and return on investment.

Finally, the change management discipline type 202e defines a discipline characteristic that encapsulates how a high performance businesses demonstrate an ability to foster and manage innovation enables them to undergo continuous renewal. As businesses grow and mature, they risk becoming resistant to innovation and change. Applicants have found that, top management teams of high performers understand that challenges and answers to one phase in the life of a product or an organization often do not carry across to the next.

Organizations must actively pursue incremental innovation—often under the mantle of “continuous improvement”—while at the same time seeking out (or acquiring options on) disruptive innovations. At heart is an innovation mindset focused on renewal—not static reproduction but steady improvement punctuated by breakthroughs that change the nature of competition.

High-performance businesses continually find ways to keep their organizations on their toes moving towards continuous renewal and improvement. This can be done by, for example, encouraging and rewarding people to shoulder three simple but powerful responsibilities: doing the work in a way that accomplishes the specified objective; improving the way work is done, whether individually or collectively, to continuously improve performance; and revolutionizing the work by seeking out the next wave of products and processes that could disrupt even the most efficient status quo.

Of course, while these duties aren't the task of every employee in a high-performance business, they are the task of appreciably more employees than at most organizations. A high-performance company could have made it a practice, for example, to document internal benchmarks (“pacesetters”) and has established simple but effective cross-departmental reward systems to encourage people to achieve record-level outputs by “copying with pride.”

By embracing the challenge of continuous renewal, high-performance businesses recognize the need to explicitly address continuity and organizational learning so that the company does not lose learning-curve benefits or simply zigzag with the latest management fad. For example, creating a process for managers from widely divergent lines of business to share lessons learned in critical leadership areas, such as managing transitions, and venturing into new markets and exiting failing businesses can serve the betterment of this discipline characteristic.

The framework, the preferred embodiment of which being depicted in FIG. 2, enables one to identify which business entities are high performance businesses by establishing qualitative and quantitative metrics for the various discipline characteristics across the three main building blocks of a high performance business and diagnostics for accessing such metrics. This, in turn, provides informative and valuable information regarding the financial performance of a subject business entity and their competitors that can be used in making strategic decisions and forecasts. Further, the framework of the present invention provides a mechanism for identifying, understanding and communicating the attributes of high performance businesses.

Referring again to FIG. 1, the steps and results of the research phase having thus been described, the execution phase of high performance business emulation process 100 can thereafter proceed to utilize the high performance business framework of FIG. 2 and associated industry drivers and diagnostics to assess and provide guidance for a subject company trying to emulate the characteristics of high performance businesses in their relevant industries. The research phase of process 100 begins at step 104 with the use of the high performance business framework and associated diagnostics tools (as will be described hereafter in detail) to diagnose the gap between the position/performance of the subject company and the position/performance of relevant high performance businesses. The various diagnostics used for each of the three building blocks of the high performance business framework will be discussed in further detail below.

Various diagnostics are established according to preferred embodiments of the invention to obtain the appropriate data and analyze the metrics relating to the discipline characteristics under each building block. For each building block answers to key questions can be asked to relevant executives within the business entity being diagnosed. Additionally, discipline characteristics for the distinctive capabilities building block can be further assessed and measured using an executive level diagnostic, which comprises a questionnaire (more lengthy relative to the “key questions”) being circulated to various different members of lower management. A similar deeper level diagnostic, labeled an organizational performance assessment, can be performed with regard to the performance anatomy building block for similar purposes. The assessments could produce, for example, correlated data that can be provided to management of the diagnosed business entity in the form of various reports and data describing the various discipline characteristics of the diagnosed entity relative to high performance businesses, such as in graphic or other readily digestible form.

In this regard, several diagnostics are established according to preferred embodiments of the invention to obtain the appropriate data and analyze the metrics relating to the discipline characteristics under each building block. Understandably, much of the necessary information for performing the gap analysis can be readily obtained from various different levels of management. Thus, for each building block answers to key questions can be asked to relevant executives within the business entity being diagnosed. Additionally, discipline characteristics for the distinctive capabilities building block can be further assessed and measured using an executive level diagnostic, which comprises a (more lengthy relative to the “key questions”) questionnaire being circulated to various different members of lower management. A similar deeper level diagnostic, labeled an organizational performance assessment, can be performed with regard to the performance anatomy building block. These assessments and key questions will be described in further detail in the separately labeled subsections below.

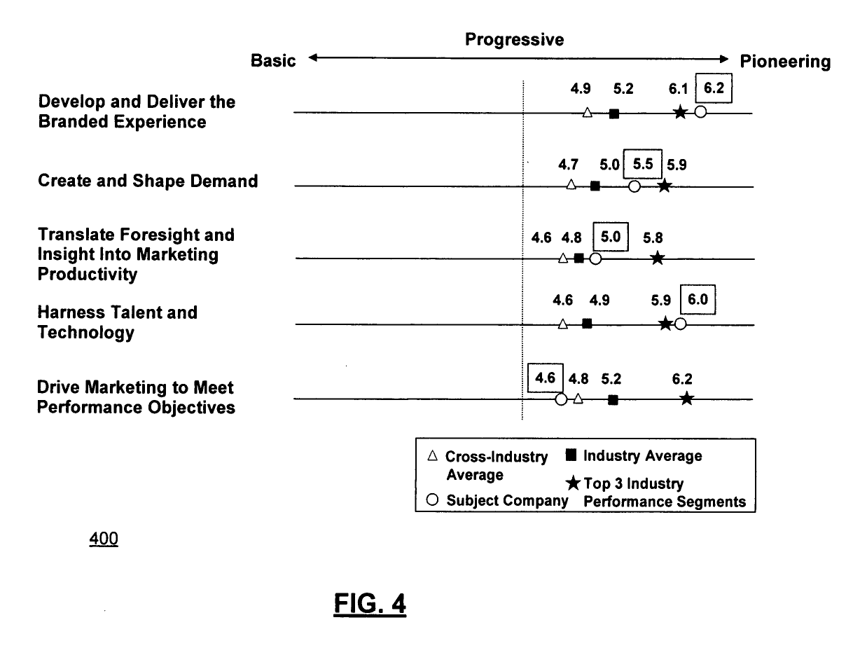

The end result of these assessments could be, for example, correlated data that can be provided to management of the diagnosed business entity in the form of various reports and data describing the various discipline characteristics of the diagnosed entity relative to high performance businesses, such as in graphic form like the testing summary chart depicted in FIG. 4.

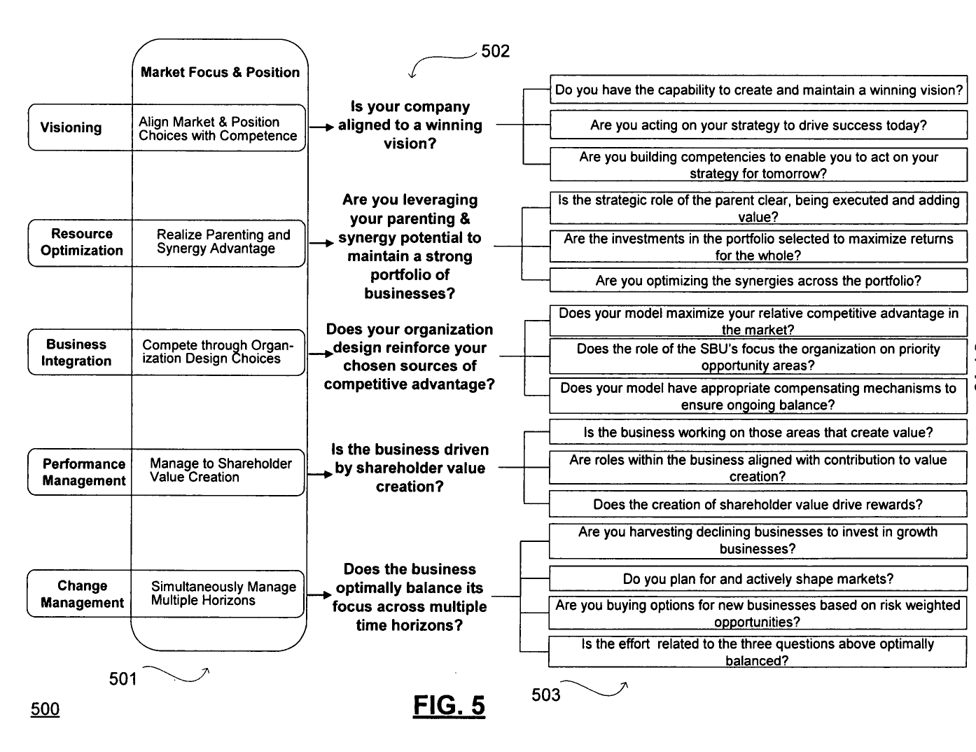

The framework according to preferred embodiments of the present invention utilizes an investigation using sample questionnaire questions 503 to obtain data concerning key questions 502 for each discipline characteristic 501 defined by the high performance business framework for the market focus and position building block. Examples of such key questions for this building block according to preferred embodiments of the present invention are depicted in FIG. 5.

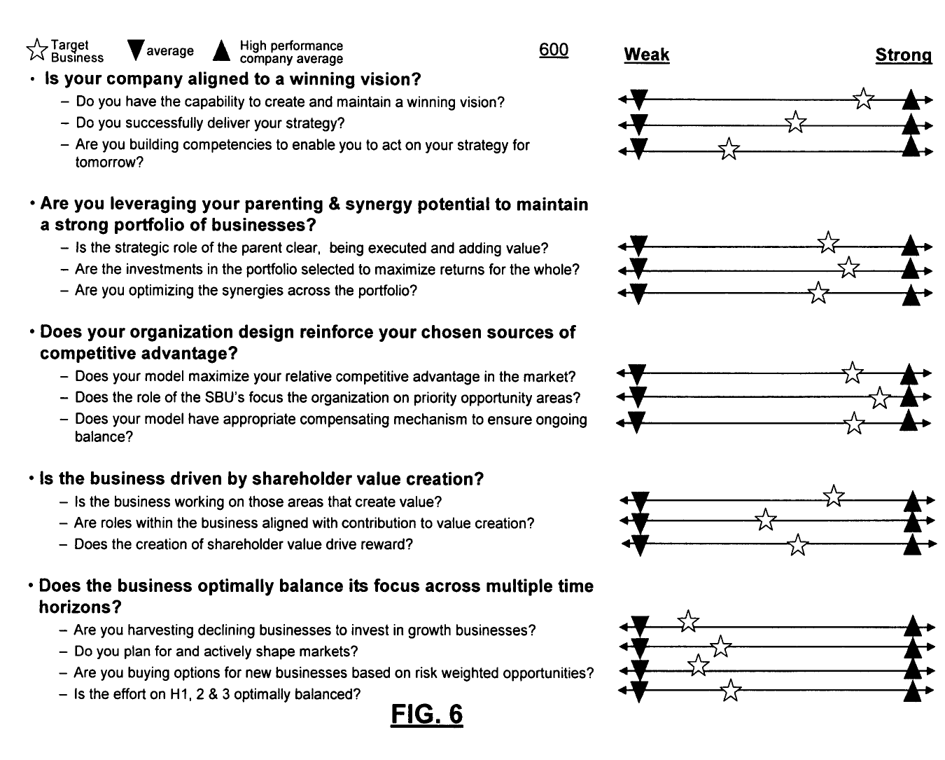

The answers to these key questions as obtained from executives and the like are utilized to prepare reports, graphs and other feedback that can be used to illustrate where a business entity is or is not matching the performance of high performance businesses in a discipline characteristic. For example, the sample scorecard 600 depicted in FIG. 6 demonstrates how the performance of a target business can be illustrated on a sliding scale for key questions associated with the discipline characteristics.

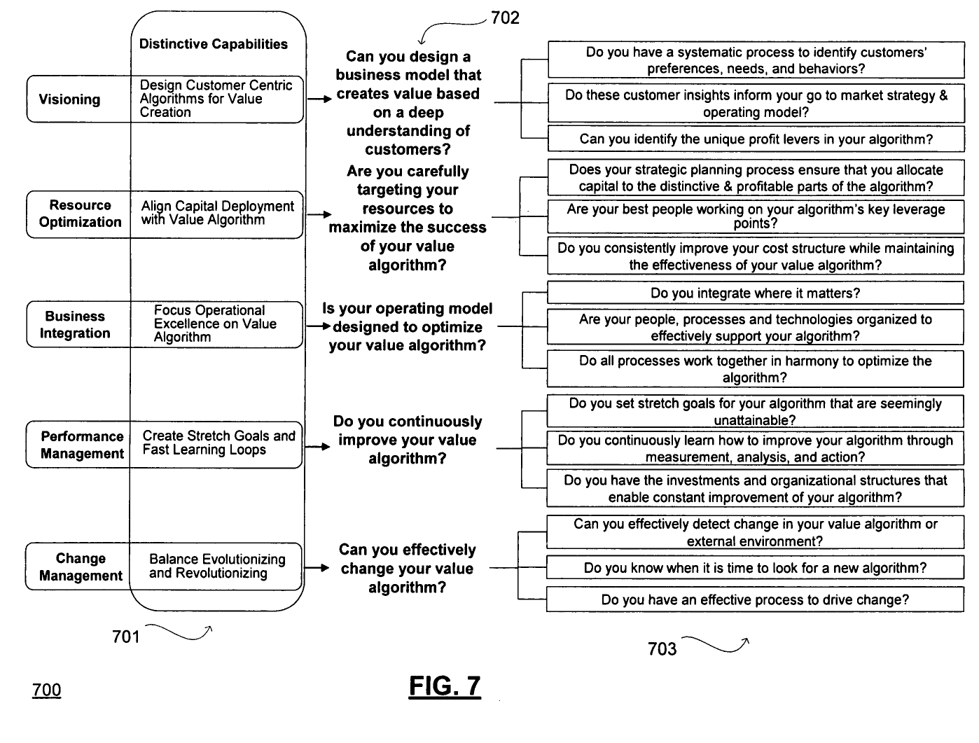

Step 104 of emulation process 100 according to the present invention also utilizes an investigation using key questions to obtain data concerning the distinctive capabilities building block. Examples of such key questions 702, with examples of associated specific questionnaire questions 703, for the distinctive capabilities building block according to preferred embodiments of the present invention are depicted in FIG. 7 with reference to associated discipline characteristics 701 from framework 200. As noted above with respect to the first building block. The answers to these key questions are obtained from executives and the like, which are then utilized to prepare reports, graphs and other feedback that can be used to illustrate where a business entity is or is not matching the performance of high performance businesses in a discipline characteristic.

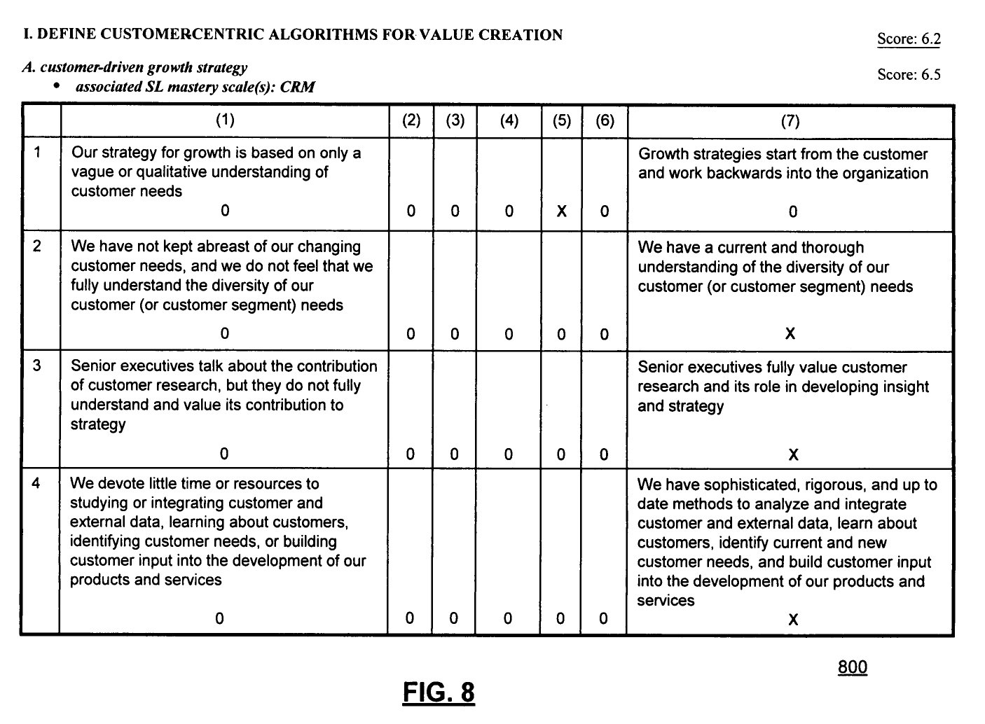

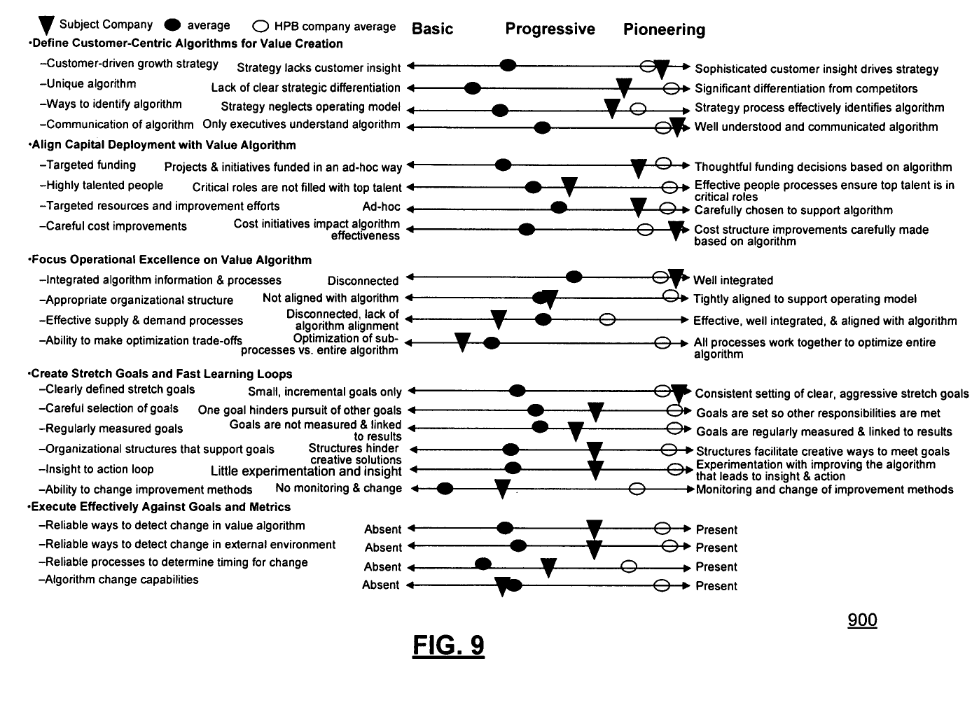

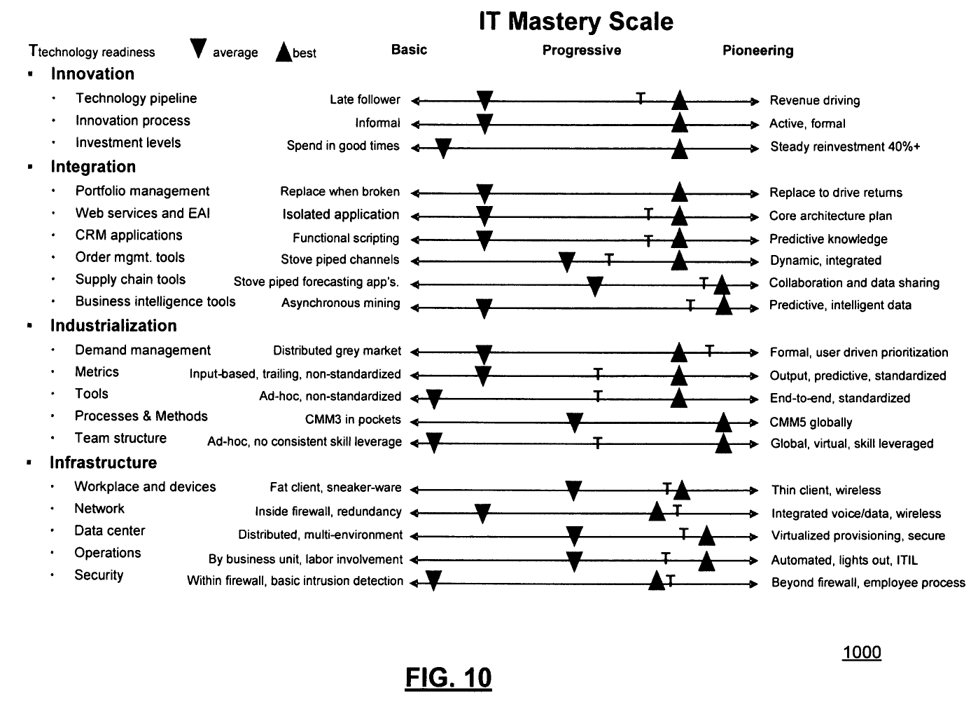

Furthermore, the framework of the present invention for the distinctive capabilities building block also employs a distinctive capabilities executive level diagnostic to obtain information concerning the five relevant discipline characteristics. FIG. 8 shows a questionnaire 800 of sample questions as they might be answered by a fictional executive. In such a questionnaire 800, the executive would be given an instruction to rank his company's performance within a spectrum of two extremes, and that ranking would be used from rakings obtained from other such questionnaires to compile useful scorecards for performing the gap analysis. The diagnostic, alone or in combination with the key questions for the distinctive capabilities building block, can be utilized to prepare an executive level scorecard, such as the sample scorecard 900 as depicted in FIG. 9 (which may generally be similar to the scorecard of FIG. 6 described above), can be associated with one or more service line mastery scales, such as the sample mastery scales report 1000 as depicted in FIG. 10, or can otherwise be used to baseline the performance of a business entity against that of a high performance business for the distinctive capabilities building block 201b.

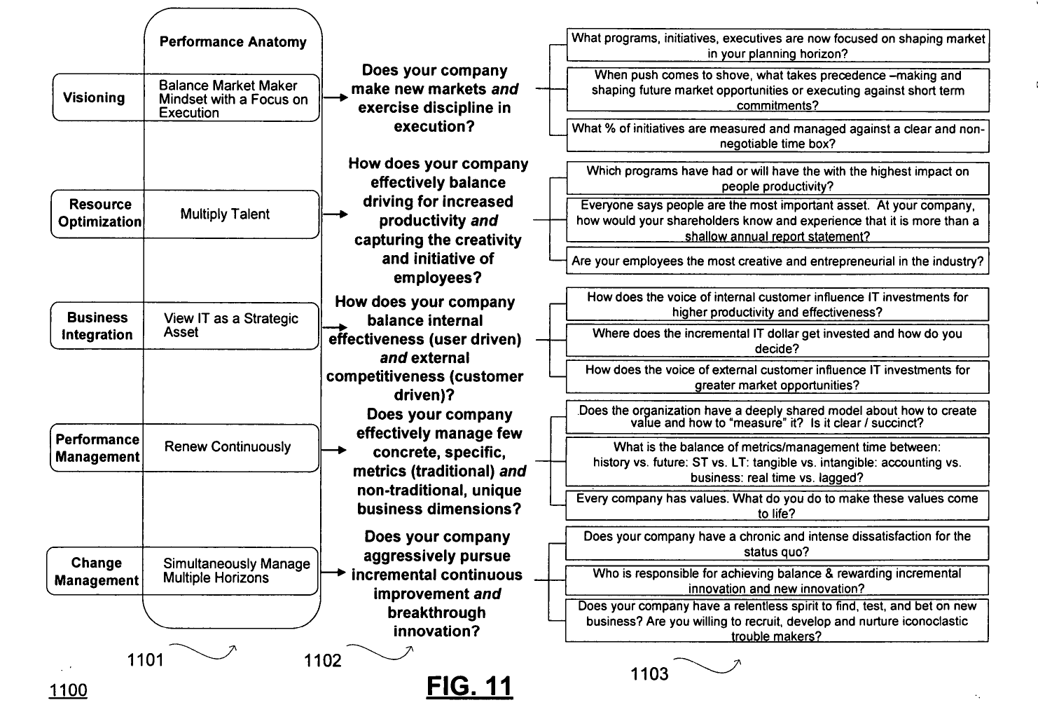

As shown in FIG. 11, the preferred framework according to the present invention also utilizes an investigation using key questions 1102, with associated sample questionnaire questions 1103, to obtain data concerning the various discipline characteristics 1101 of the performance anatomy building block. As noted above, the answers to these key questions are obtained from executives and the like, which are then utilized to prepare reports, graphs and other feedback that can be used to illustrate where a business entity is or is not matching the performance of high performance businesses in a discipline characteristic.

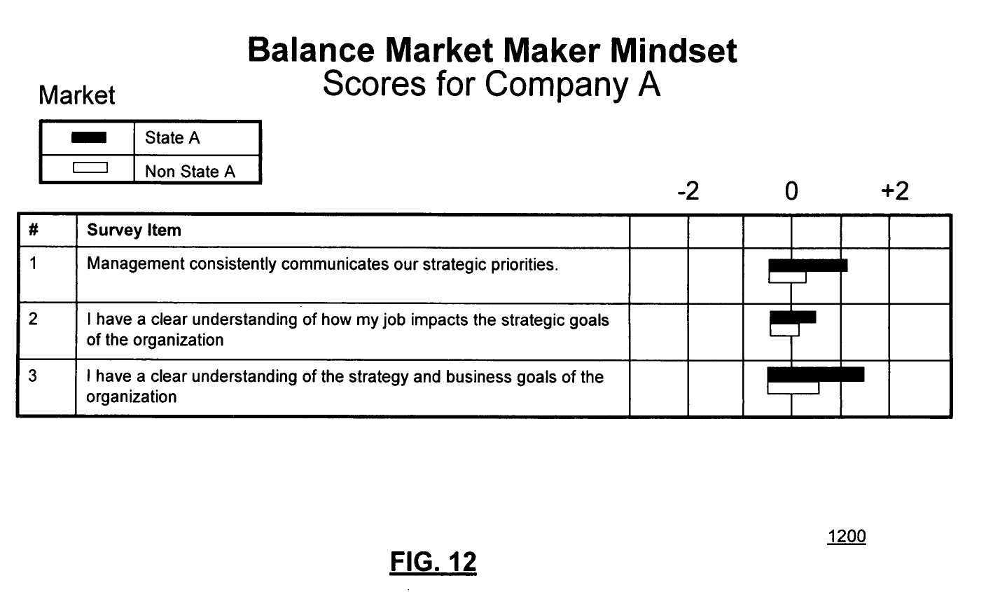

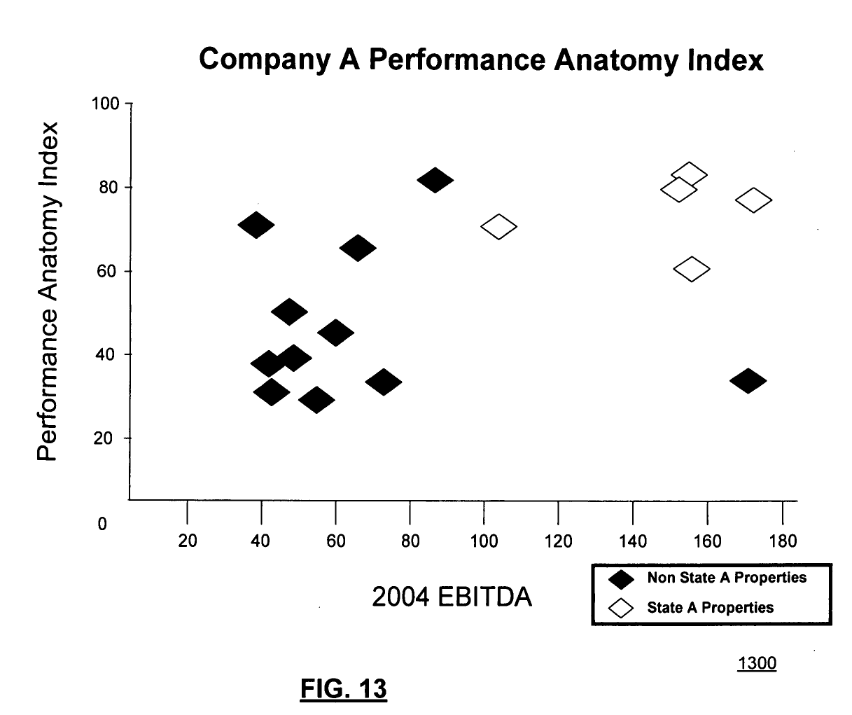

Also, the framework of the present invention for the performance anatomy building block also preferably employs a organizational performance assessment diagnostic to obtain information concerning the five relevant discipline characteristics. FIG. 12 depicts a sample score report 1200 generated from the organizational assessment. This diagnostic, alone or in combination with the key questions for the performance anatomy building block, can be utilized to prepare a performance anatomy index (e.g., a scaled score) and appropriate diagrams. For example, FIG. 13 depicts a sample performance anatomy index plot diagram 1300 that could be used to visually depict the relationship of various composite performance anatomy scores for various businesses.

Referring again to FIG. 1, once the appropriate gaps have been diagnosed, the high performance business framework can then be utilized at step 105 to link the identified gaps to solutions for remedying the gaps (i.e., mechanisms for changing the position/performance of the subject company such that it mimics that of high performance businesses in relevant peer groups). Finally, high performance business emulation process 100 thereafter concludes at step 106 with the initiation, implementation, and management of the solutions identified at step 105. In this regard, process 100 attempts to implement select solutions intended to place the subject company in a position similar to that of known high performance businesses and thus direct the subject company to adopt business decisions, practices, and mindsets that are proven to lead to success.

For example, in the event that poor or less than peak performance is identified for one or more discipline characteristics, various improvement mechanisms could be used in strategic efforts by the entity to adopt building block structures and characteristics more commonly shared by high performance businesses. This could comprise, for example, the establishing of a database of service offerings that are correlated to expected results/impacts upon key financial metrics and upon the various industry drivers associated with the framework. In this regard, the results of the gap analysis at step 104 of high performance business emulation process 100 could be used to directly identify potential solutions that could be used by the subject company to adopt high performance business practices and performance discipline characteristics.

Understandably, certain preferred embodiments of the present invention incorporate aspects of the emulation process as described herein into electronically enabled tools for automatically performing gap analyses and identifying solution strategies for helping a subject company best emulate the building block features of high performance businesses. In particular, such preferred embodiments of the invention incorporate various steps of emulation process 100 into an electronic tool, preferably implemented via computer operated software, that link to and interact with a repository of compiled case studies or strategic plans that are organized according to various high performance business emulation strategies such that case studies and/or plans of particular interest may be identified readily within the repository and then analyzed with respect to the situation of a subject company.

These electronic tools according to embodiments of the invention link the identified gap areas to one or more pertinent business strategy recommendations where each linked strategy recommendation is tailored to provide at least one element of a transformation solution adapted to target one or more of the identified gap areas that cause the subject company to lag behind peers in their respective industry that have achieved aspects of high performance businesses. Further, the embodiments of the invention provide a solution overview for each recommendation, where the overview can contain case studies, implementation plans, integration implications, sample benefit and impact forecasts and other relevant information pertaining to the understanding, assessment and implementation of that particular capability recommendation. In this manner, a user is provided with a substantially simplified way to identify possible transformative solutions that may be of interest to the subject company, as well as obtain useful information that provides guidance regarding the selection and implementation of those strategies.

Specifically, the various solution recommendations may be linked by a linking module of a software tool with various discipline characteristics of the high performance business framework to which those solutions are known to be relevant. In this manner, appropriate strategies that may be adopted by a target company to emulated the business blocks of a high performance business can be identified and implemented more easily.

Notably, data concerning the identified industry drivers and diagnosed gaps may be used as inputs to the high performance business emulation strategy tool. In one such preferred embodiment, the high performance business emulation strategy tool can include a solution-linking module and an solution overview/case study repository module both in electronic intercommunication. Taking the various identified drivers and diagnosed gaps as inputs (either automatically from automated software tools supporting the various diagnostics used to diagnose the gap, or as manual inputs), the high performance business emulation strategy tool provides suggested solutions that have a history showing them as being suitable for the particular subject company to adopt certain desired aspects of high performance businesses in its industry. Each of the business capability recommendations may be linked by the capability-linking module to one or more capability overviews maintained in a repository, such as an electronic database. The capability overviews are associated with the leading and/or emerging best practices in one or more industries with respect to that capability, and the overviews preferably include case studies that focus on the financial benefits achieved by particular business capabilities in certain circumstances. In this manner, appropriate high performance business emulation strategies suitable for a target company can be identified and explored.

While various embodiments of the present invention have been shown and described herein, it will be obvious to those skilled in the art such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope by the claims that follow.

1. A computer storage medium encoded with instructions embodying a computer program, the computer program adapted to perform operations to assist a subject company in achieving high performance by emulating the characteristics of known high performance businesses, said operations comprising:
diagnosing the gap between a subject company and said identified high performance businesses using a high performance business framework, said high performance business framework reflecting industry drivers identified for known high performance businesses from a plurality of industries, said high performance business framework defining a plurality of discipline characteristics common to said known high performance businesses as the intersection of a plurality of building blocks with a plurality of discipline types, and wherein said diagnosing is performed by correlating data for assessments for each said building block;
linking diagnosed gap areas affecting said subject company with a repository of stored solution overviews particularly adapted for improving said gap areas, said linking correlating various business strategies with a plurality of gap areas and said overview module providing information relevant to each said business strategies, said relevant information being useful to understand, assess and implement a particular strategy recommendation for the subject company.

2. The computer storage medium according to claim 1, wherein said discipline types include visioning, resource optimization, business integration, performance management, and change management.

3. The computer storage medium according to claim 1, wherein said building blocks include market focus and position, distinctive capabilities, and performance anatomy.

4. The computer storage medium according to claim 3, wherein said market focus and position building block is comprised of industry drivers relating to the decisions made by high performance businesses to maximize growth opportunities and structural economic advantage.

5. The computer storage medium according to claim 3, wherein said distinctive capabilities building block is comprised of industry drivers relating to the practices of high performance businesses used to maximize competitive differentiation.

6. The computer storage medium according to claim 5, wherein said diagnosing of said gap utilizes data obtained from select managerial employees of said subject company via an executive level diagnostic focusing on known drivers for said distinctive capabilities building block.

7. The computer storage medium according to claim 3, wherein said performance anatomy building block is comprised of industry drivers relating to the mindsets adopted by high performance businesses in efforts to out-execute the competition.

8. The computer storage medium according to claim 5, wherein said diagnosing of said gap comprises utilizes data collected from an administered organizational performance assessment that focuses on known drivers for said performance anatomy building block.

9. The computer storage medium according to claim 1, wherein said diagnosing of said gap utilizes data collected from questionnaires that address key questions for each discipline characteristic which were administered to select managerial employees of said subject company.

10. The computer storage medium according to claim 9, wherein said key questions focus on qualitative and quantitative metrics for said discipline characteristics across the three building blocks.

11. A method for assisting a subject company in achieving high performance by emulating the characteristics of known high performance businesses, said method comprising:
screening for and identifying high performance businesses for a universe of businesses from a plurality of industries;
determining industry drivers for said identified high performance businesses in each of said industries;
synthesizing said determined industry drivers to adopt a high performance business framework, said high performance business framework defining a plurality of discipline characteristics common to said known high performance businesses as the intersection of a plurality of building blocks with a plurality of discipline types;
diagnosing the gap between a subject company and said identified high performance businesses according to said high performance business framework, said diagnosing comprising performing assessments for each said building block;
linking diagnosed gap areas affecting said subject company with a set of known solutions particularly adapted for improving said gap areas; and
initiating and managing one or more of said solutions to emulate the decisions, practices, or mindsets of said known high performance businesses.

12. The method according to claim 11, wherein said discipline types include visioning, resource optimization, business integration, performance management, and change management.

13. The method according to claim 11, wherein said building blocks include market focus and position, distinctive capabilities, and performance anatomy.

14. The method according to claim 13, wherein said market focus and position building block is comprised of industry drivers relating to the decisions made by high performance businesses to maximize growth opportunities and structural economic advantage.

15. The method according to claim 13, wherein said distinctive capabilities building block is comprised of industry drivers relating to the practices of high performance businesses used to maximize competitive differentiation.

16. The method according to claim 15, wherein said diagnosing of said gap comprises administering to select managerial employees of said subject company an executive level diagnostic focusing on known drivers for said distinctive capabilities building block.

17. The method according to claim 13, wherein said performance anatomy building block is comprised of industry drivers relating to the mindsets adopted by high performance businesses in efforts to out-execute the competition.

18. The method according to claim 15, wherein said diagnosing of said gap comprises administering an organizational performance assessment focusing on known drivers for said performance anatomy building block.

19. The method according to claim 11, wherein said diagnosing of said gap comprises administering to select managerial employees of said subject company questionnaires that address key questions for each discipline characteristic.

20. The method according to claim 19, wherein said key questions focus on qualitative and quantitative metrics for said discipline characteristics across the three building blocks.

21. The method according to claim 11, wherein said linking of said diagnosed gap areas with said set of known solutions utilizes a high performance business emulation strategy tool, said strategy tool including a business strategy recommendation linking software module and a database of solution overviews, said linking module correlating various business strategies with a plurality of gap areas and said overview module providing information relevant to each said business strategy, said relevant information being useful to understand, assess and implement a particular strategy recommendation for the subject company.

22. The method according to claim 21, wherein each solution overview may contain information types selected from the group consisting of case studies, implementation plans, integration implications, sample benefit and impact forecasts, and combinations thereof.

23. The method according to claim 21, wherein said strategy tool can produce strategy implementation plan templates for the subject company concerning a selected strategy recommendation upon a user selecting said recommendation.

24. The method according to claim 23, wherein said template can include implementation information useful for the subject company in applying a recommended strategy.

25. The method according to claim 24, wherein said implementation information is of types selected from the group consisting of economic impacts, strategy goal summaries, expected implementation schedules and plans, projected cost considerations, and projected key benefits.
